(19) United States
(12) Patent Application Publication
(10) Pub. No.: US 2010/0148941 A1
(43) Pub. Date: Jun. 17, 2010

(54) INDICATING ARTICLE, DEVICE AND METHOD

(76) Inventors: Kathleen Haeselin, Montrose, PA (US); Timothy Haeselin, Montrolse, PA (US)

Correspondence Address: CHRISTINE JOHNSON ESQ., 151 Trenton Rd., Fairless Hills, PA, 19030, US

(21) Appl. No.: 12/615,233

(22) Filed: Nov. 9, 2009

Related U.S. Application Data
(60) Provisional application No. 61/112,988, filed on Nov. 10, 2008.

(51) Int. Cl. G08B 6/00; B32B 1/02

(52) U.S. Cl. 340/407.1; 428/34.1

(57) ABSTRACT

The invention provides devices and methods for indicating a shopper to retrieve his or her reusable shopping bag from the home or vehicle as the shopper embarks on a shopping trip. A device according to one embodiment of the invention includes a down-scaled general replica of a re-usable shopping container. The down-scaled replica includes at least one handle providing a coupling portion for coupling the replica to a key retaining device. The replica is positioned with respect to a key retained on the key retaining device so as to bring the replica into contact with a person's hand when the person grasps the key. The replica is defined by a characteristic feature of the re-usable shopping container. The characteristic feature is perceptible via a tactile stimulus delivered via the contact between the replica and the hand of person grasping the key. The indicating article thereby delivers a tactile indicator related to the re-usable shopping bag when the person grasps the key.

### CROSS REFERENCE TO RELATED APPLICATIONS

This application claims benefit of U.S. provisional application Ser. No. 61/112,988 filed Nov. 10, 2008 naming the same inventor, the specification of which is hereby incorporated by reference in its entirety.

### FIELD OF THE INVENTION

The present invention relates generally to devices and methods for conveying warnings and indications via at least one of the senses and more particularly to devices where an indication is perceived by the sense of feeling.

### BACKGROUND OF THE INVENTION

The invention provides a device for indicating to a shopper a signal suggesting to retrieve a re-usable shopping bag. The indication is imparted by the sense of touch when the shopper grasps a key to the shopper's vehicle, for example, when the shopper exits the vehicle to enter a store to shop. Further, embodiments of the indicating article of the invention enable a shopper to perceive the indication through the sense of touch when withdrawing a vehicle key from a shopper's pocket as the shopper enters a vehicle to embark on a shopping trip.

Grocery shoppers are increasingly concerned about the environmental impact of paper and plastic shopping bags of the type provided by grocery stores and supermarkets. Plastic bags eventually become litter. Once in the environment, it may take months to hundreds of years for plastic bags to breakdown. Paper bags are an alternative to plastic bags. While paper bags may degrade more rapidly than plastic bags, paper bags also present drawbacks related to environmental conservation. For example, paper bags take more energy to manufacture than plastic. In addition trees are destroyed in producing paper bags.

In an attempt to mitigate the above drawbacks many environmentally conscious shoppers are turning to reusable bags. A shopper can buy a sturdy reusable bag in a wide variety of available materials. The same bag can be reused on each trip to a grocery store or other purchase location. This alternative approach is rapidly becoming popular, and in some cases, mandatory.

However, many shoppers are unaccustomed to carrying their own bag on a shopping trip. As a result, it is common for a shopper to forget to take the re-usable bag with them as they exit their home or vehicle to visit a store. When the re-usable bag is left behind, a shopper may, or may not have the option to use a store's ‘paper or plastic’ disposable bag. In some situations, the shopper must return to his or her home or vehicle to retrieve the reusable shopping bag. This is a time consuming action which may be impractical or inconvenient for the shopper.

What are needed are devices and methods for indicating a shopper to retrieve his or her reusable shopping bag from his or her home or vehicle as the shopper embarks on a shopping trip. Further needed are devices and methods that provide such an indicator at an appropriate and convenient time, that is, before the shopper has departed from the home or vehicle to the extent that return to the home or vehicle would be inconvenient, impractical or impossible.

Electronic reminders are sometimes used to provide audible reminders to a user. Audible reminders include beeps, tones, voice messages or other alerts related to tasks or events to be brought to the attention of a user. Such reminders are typically associated with, for example, a calendar date or time of day on which a task is to be performed, or brought to a user's attention. However, it would be impractical in many situations to employ an electronic reminder to remind a shopper about retrieving a re-usable shopping bag. An exact time at which such a reminder should be delivered to the shopper is frequently un-predictable. Further, a shopper is often required to remember to carry the electronic reminder device, in addition to remembering to carry the re-usable shopping bag. This situation can defeat the purpose of the reminder device. Further needed are devices and methods that provide an indicator to a shopper at an appropriate and convenient time, that is, at a time generally co-incident with the shopper departing from the home or vehicle.

Visual, for example, printed text indicators, such as printed signs, symbols and other printed markings provide another conventional means of reminding people to do certain things. For example, a shopper might attach a sign stating: “Take your shopping bag” on an exit door of their home, or on, for example, a rear-view mirror of their automobile. Or a shopper may carry a card bearing the printed text “take your shopping bag” in the shopper's wallet. However, such a tactic can be unsightly or introduce an undesirable aesthetic effect on its surroundings. In the case of automobile signs, posting a sign within the auto could be unsafe. Further, such a technique might present the indication at inappropriate times, and fail to present the indication at an appropriate time. Further, printed text and other printed signs and symbols may be placed in locations not likely to come within a shoppers view at an appropriate time for an indication, for example in a wallet. Therefore such visual indications are likely to be ignored or otherwise ineffective.

It would be desirable to provide a reminder device that does not affect the aesthetic surroundings in which it is deployed, and does not require the user to know in advance an exact time or date in which the reminder should be delivered, and does not require the user operate a pre-set a timer or other electronic reminder device. Further, it would be desirable to provide a reminder device that does not impair safety when deployed in an automobile. Further it would be desirable to provide a reminder device that need not be carried separately from other articles that a shopper typically carries on a shopping trip. Further it would be desirable to provide a reminder device that does not rely on a shopper's visual perception of printed text, or perception of other printed signs and symbols.

The invention provides devices and methods for indicating a shopper to retrieve his or her reusable shopping bag from the home or vehicle as the shopper embarks on a shopping trip.

### DESCRIPTION OF THE DRAWING FIGURES

Further objects, features and advantages of the invention will be apparent from a consideration of the following detailed description of the invention considered in conjunction with the drawing figures, in which:

FIG. 1 illustrates an indicating article comprising an indicating device according to an embodiment of the invention;

FIG. 2 illustrates an indicating article according to an embodiment of the invention;

FIG. 3 illustrates a perspective view of an indicating article according to an embodiment of the invention;

FIG. 4 illustrates an indicating article comprising an indicating device according to an embodiment of the invention;

FIG. 5 illustrates an indicating article according to an embodiment of the invention;

FIG. 6 illustrates an indicating article according to an embodiment of the invention

FIG. 7 illustrates an indicating article according to an embodiment of the invention;

FIG. 8 illustrates a representative example of an article indicated by an indicating article of an embodiment of the invention wherein the indicated article comprises a conventional full scale shopping bag;

FIG. 9 illustrates an indicating article comprising a reminder device according to an embodiment of the invention;

FIG. 10 illustrates an indicating article according to an embodiment of the invention;

FIG. 11 illustrates an indicating article according to an embodiment of the invention;

FIG. 12 illustrates an indicating article according to an embodiment of the invention as seen positioned to deliver a tactile indication to a shopper;

FIG. 13 illustrates an indicating article according to an embodiment of the invention as seen positioned to deliver a tactile indication to a shopper;

FIG. 14 illustrates a side view of an indicating article fabricated from a swatch of material and depicting a coarse material texture according to one embodiment of the invention;

FIG. 15 illustrates an indicating article coupled to a key ring including an ignition key inserted into an ignition lock of an automobile, and further showing relationship of a driver's hand to the indicating article according to an embodiment of the invention;

FIG. 16 illustrates an indicating article according to an embodiment of the invention and further illustrates a driver's hand in a position for insertion into a pocket of the driver;

FIG. 17 illustrates a driver's hand contacting an indicating article according to an embodiment of the invention as the driver's hand is positioned substantially inserted into a pocket of the driver.

### DETAILED DESCRIPTION OF THE INVENTION

The invention provides an indicating device, an indicating article and an indicating method. For purposes of this specification, the term “indicator” refers to any stimulus delivered via a human sensory organ with the aim of exciting a physical, mental, or emotional action, re-action or response from the human receiving the stimulus. The term “tactile indicator” refers to a stimulus pertaining to, endowed with, or affecting the human sense of touch. Therefore, a tactile indicator is an indicator which is perceptible to the touch. Accordingly, the terms “indicating article” and “indicating device” refer to tangible objects. Further, according to some embodiments of the invention, a tactile indicator is configured so as to provide a visual indication.

According to one embodiment of the invention, an indicating device comprises an indicating article coupled to a key retaining mechanism such as a key ring or key fob. In one embodiment of the invention, the indicating device includes a vehicle key coupled to the key retaining mechanism. An indicating article, according to embodiments of the invention, comprises a tangible object capable of providing a tactile stimulus to a human. According to some embodiments of the invention, an indicating article comprises a tangible object further capable of providing a visual stimulus to a human. According to other embodiments of the invention, an indicating article comprises a tangible object capable of simultaneously providing a tactile and visual indication to a human.

In one embodiment of the invention a tactile indicating article is generally defined by a textured material that relates to a corresponding indicated response article. For purposes of this specification, the term “response article” refers to an object about which a person desires to be reminded. The indicating article, device and method herein provide reminders to a person to take some action with respect to a response article. The reminder is delivered when the indicating article contacts a sensory organ, for example, a hand, of the person employing the indicating article.

For example, a tactile indicating article of one embodiment of the invention comprises a down-scaled model of a full sized shopping bag. For purposes of this specification, the term ‘full size’ shopping bag refers to shopping bags of any conventional size intended for actual use in stowing shopping items. The invention is particularly useful to remind shoppers to retrieve a re-usable shopping bag for grocery shopping. The indicating device delivers a reminder at a time when the shopper is most likely to deploy the re-usable shopping bag, e.g., upon grasping vehicle keys when exiting a home or vehicle.

It will be recognized that conventional shopping bags are available in a wide variety of shapes and sizes. In contrast, an indicating article of the invention comprises a down-scaled model of an actual response device, such as an actual shopping bag. As such, indicating articles of the invention are characterized by a shape generally similar to the shape of a shopping bag, but are of a size that is a fraction of the size of a conventional shopping bag. Indicating articles of the invention comprise a representation, for example a miniature version, of the indicated response article.

At the same time, indicating articles of the invention define at least one characteristic of a corresponding response article. For example, an indicating article according to one embodiment of the invention comprises a miniature shopping bag defined by at least one characteristic of an actual shopping bag. Characteristics, other than size, of an actual shopping bag include texture, shape, form, or other feature associated with an actual shopping bag and conveyable by the sense of touch.

In one embodiment of the invention an indicating article comprises a scaled model of a response article. In one embodiment of the invention the model comprises a swatch of material having a texture that provides a tactile stimulus when the article comes into contact with a potential shopper's hand. The tactile stimulus provided by texture of the indicating article is perceptible by the potential shopper as similar to material of the shopper's re-usable shopping bag. Therefore, the tactile stimulus provides a reminder to the potential shopper regarding an action to take with respect to the shopper's actual shopping bag. Accordingly, the potential shopper is reminded to retrieve the corresponding full scale shopping bag when the indicating article contacts the potential shopper's hand.

In some embodiments of the invention, an indicating article comprises a shape similar to a shape of the response article. Regardless of shape, the configuration of the cuing article is such that a user's hand is likely to come in contact with the cuing article whenever the user's hand grasps the user's keys. For example, in the act of a shopper grasping a key to remove the key from the ignition receptacle of an automobile, the indicating article coupled to the key contacts at least a portion of the shopper's hand. The indicating article is constructed such that the contact is sufficient to impart a sensory stimulation to at least a portion of the shopper's hand. The tactile sensation thus delivered to the shopper's hand is within the perceptual capability of an average shopper when grasping a typical ignition key.

In one embodiment of the invention, tactile attributes of the indicating device invoke sensory stimulation recognizable to the user as associated with a response article. For example, a tactile device comprises a material having a texture corresponding to a material texture of a re-usable shopping bag. In that manner, contact by the tactile indicating device with the user's hand as the user grasps his or her key to remove it from an ignition lock enables the user to associate a particular contacting sensation with a re-usable shopping bag. As a result, the user is reminded in a timely manner to retrieve the bag from the car.

For example, in one embodiment of the invention device provides a down-scaled model of a shopping bag. The model has a shape and texture generally corresponding to a full scale re-usable shopping bag. The model is attachable to a shopper's key ring. As the shopper grasps their keys upon exiting their vehicle, the model comes into contact with the shopper's hand, thereby providing a perceptible and timely reminder to take the full scale shopping bag from the vehicle during exit, i.e., at a time before the user enters a store in which the full scale model will be deployed.

In addition, some embodiments of the invention further provide a handy storage compartment for shopper's club cards, credit cards, or other items a shopper may consistently use while shopping.

One embodiment of the invention is implemented as a key fob and is carried with keys, on a ring or a chain. In that case the indicating article serves more than one function. First, it provides a stimulus related to response articles not coupled to the key chain. Second, it provides a better grip for one or more keys.

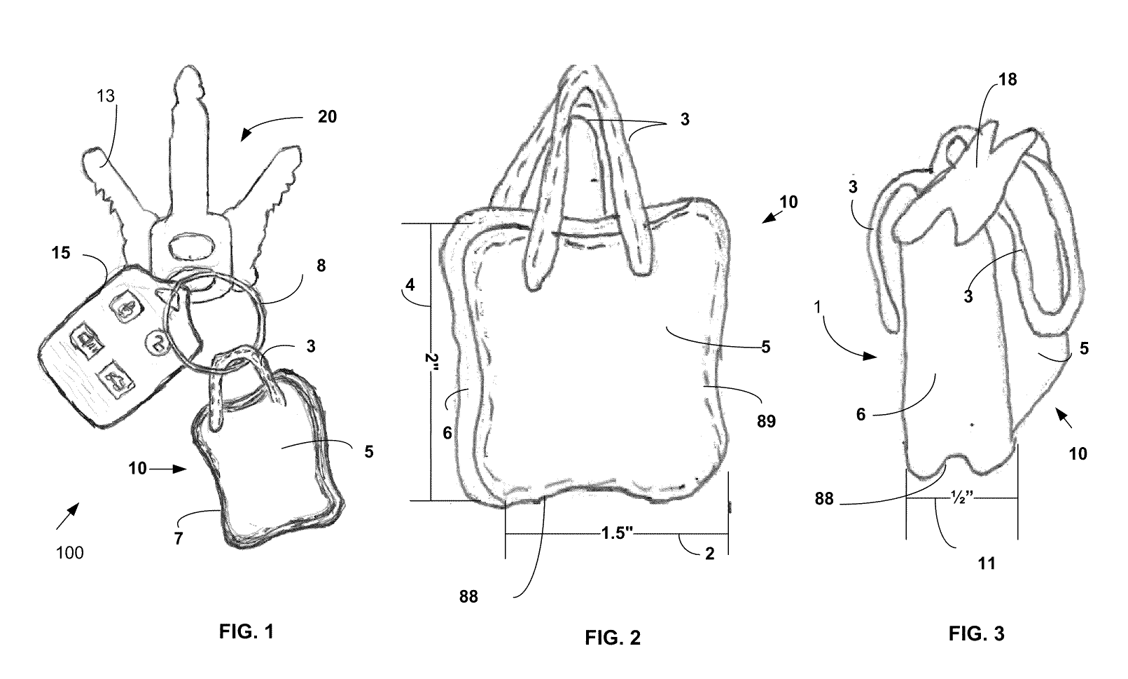

### FIG. 1

FIG. 1 illustrates an indicating article 10 comprising an indicating device 100 according to one embodiment of the invention. Indicating device 100 comprises tactile indicating article 10 coupled to at least one key 13. In one embodiment of the invention, indicating article 10 is coupled to at least one key 13 via at least one key ring 8. Some embodiments of indicating device 100 may include additional objects, such as key fob 15, also coupled to indicating device 100 via key ring 8.

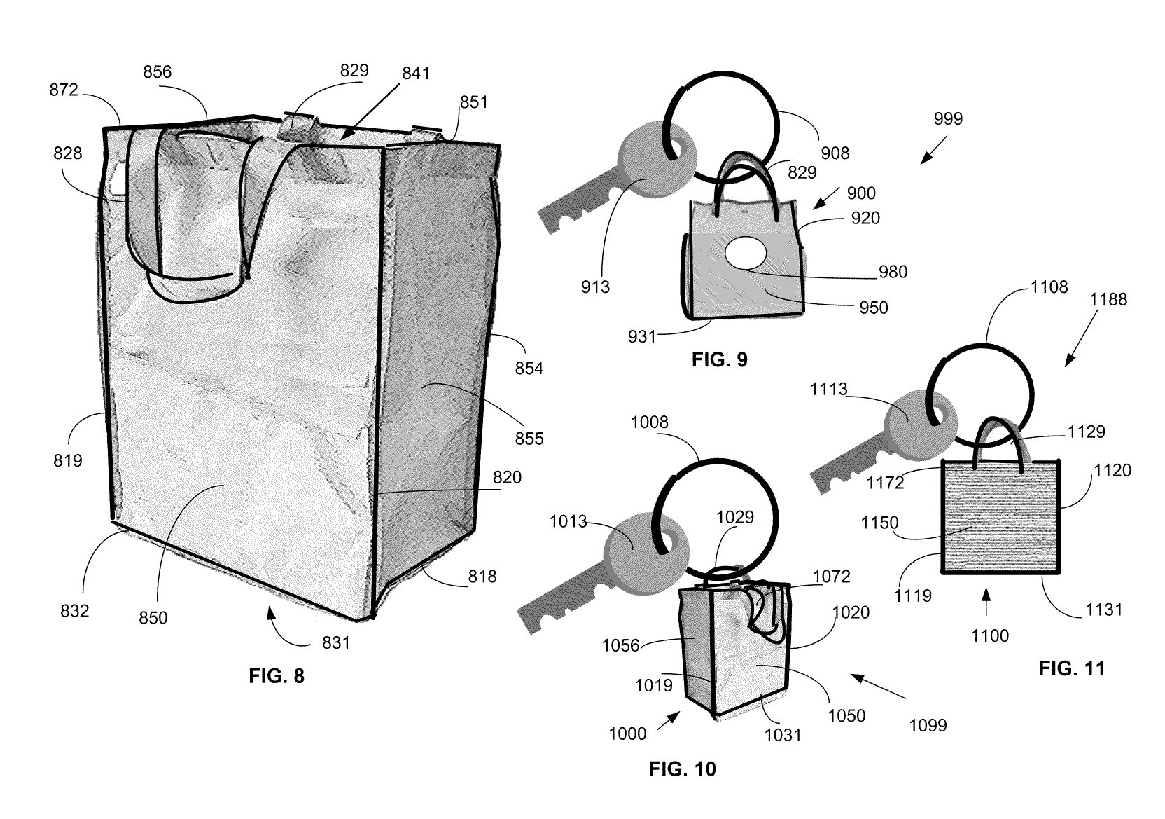

According to one embodiment of the invention, indicating article 10 comprises a miniature version of a response article. A response article is an article corresponding to an indicating article. The indicating article provides a reminder to a person to take some action with respect to the response article. For example, in one embodiment of the invention, a response article comprises a reusable shopping bag (example illustrated in FIG. 8). An indicating article comprises a swatch of material having a texture similar to, or evocative of, the texture of the response article.

In a rudimentary embodiment of the invention, a miniature version of a reusable shopping comprises a swatch of material, such as a swatch of cloth or fabric. In one embodiment of the invention a texture of the swatch generally conforms to a texture associated with the corresponding response article. In that manner, the swatch provides a tactile stimulus associated with cloth, i.e., a full scale cloth article. The tactile stimulus effectively provokes a response whereby a shopper is reminded of the corresponding full scale cloth article.

In one embodiment of the invention, tactile indicating device 10 is a reproduction of a full scale shopping bag in that device 10 includes at least one handle 3 of a type and shape typically found in conventional shopping bags. Handle 10 is attached to bag body 5 of indicating article 10. Handle 3 enables the device 10 to be affixed to key ring 3 along with, and in an attachment manner similar to that of key fob 15 and keys 20.

In some embodiments of the invention, tactile indicating article 10 further comprises a visual indicating device. In those embodiments, tactile indicating article 10 is defined by a general shape consistent with a shape of corresponding full scale article. Therefore, upon visual perception of the shape of indicating article 10, a shopper is reminded of a shopping bag.

### FIG. 2

FIG. 2 illustrates an example indicating article 10 according to an embodiment of the invention. In this example, article 10 comprises a tactile indicating device corresponding to a response article wherein the response article is a full scale re-usable shopping bag. Article 10 comprises a front body portion 5 and a rear body portion 1 (not shown). In the embodiment illustrated in FIG. 2, front body portion 5 of article 10 is seen to have a height dimension 4, of about 2 inches. In one embodiment of the invention the body portions (5 and 1) are formed to have a width dimension of about 1.5 inches.

It will be understood that the examples provided herein represent but one example embodiment. Other dimensions and sizes will be recognized as suitable dimensions for forming article 10 by one of ordinary skill in the art upon reading the enabling disclosure provided herein. In one embodiment of the invention, article 10 is sized for convenient attaching to key ring 8 and has a surface area sufficient to bring at least a portion of article 10 within tactile reach of a hand of a person carrying key ring 8. In another embodiment of the invention, article 10 has a surface area sufficiently small so as to be substantially entirely graspable within a hand of a shopper.

In one embodiment of the invention, front body portion 5 and rear body portion 1 are joined to form an open upper end 18 and a closed lower end 88. Front and rear body portions 5 and 1 are joined at the sides of article 10, by seams 89. In one embodiment of the invention, article 10 includes a replica of carrying means such as strap handles 3. In one embodiment of the invention a replica strap handle 3 is preferably formed from a continuous piece of flexible reinforced material attached to an area substantially near the outer edges of body 5 of article 10. When formed in this manner, the replica strap handle 3 provides a convenient means for affixing article 10 to a key retaining device, such as a key ring, or key fog.

In one embodiment of the present invention, indicating article 10 is formed from waterproof material to prevent damage to article 10 from exposure to water when used in rain, snow and other inclement weather conditions.

### FIG. 3

FIG. 3 illustrates a perspective view of tactile indicating article 10 similar to that illustrated in FIG. 2 according to an embodiment of the invention. Indicating article 10 is of a size small enough to enable affixing to a coupling device such as key ring 8. At the same time, indicating article 10 is sufficiently large to impart a user-perceptible sensation to a user's hand when article 10 comes into contact with the user's hand. For example, when a user grasps at least one key 20, article 10 is likely to contact at least a portion of the user's hand. When in contact with the user's hand, article 10 delivers a tactile sensation similar to that of a corresponding full scale article, in this case a re-usable shopping bag. For example, cloth materials such as cotton, polyester, linen, canvas, denim, burlap and combinations thereof are suitable for implementations of tactile indicating device 10.

In the embodiment illustrated in FIG. 3 article 10 comprises a front body portion 5, a rear body portion 1, and two side intermediate portions 6 and 7. In the embodiment illustrated in FIG. 3 each intermediate portion 6 and 7 has a width dimension 11 of about one half inch. In one embodiment of the invention, intermediate portions 6 and 7 are affixed to front and rear body portions 1 and 5 such so as to form a cavity 8 within article 10, thus providing a realistic model of a shopping bag. In that case, during use, both handle portions 3 are suitable for fitting onto key ring 8.

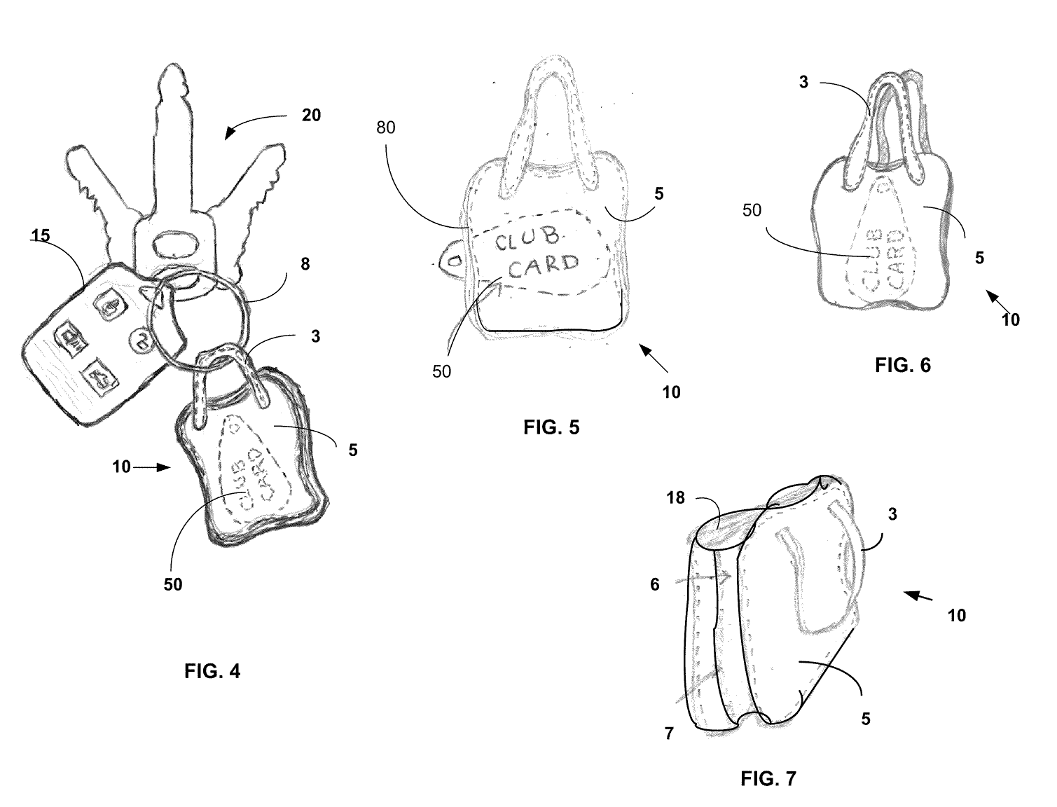

### FIG. 4

FIG. 4 illustrates a tactile indicating article according to an embodiment of the invention. In the embodiment illustrated in FIG. 4 a cavity 50 is formed on at least one of front and rear body portions 5 and 1 of article 10. Cavity 50 is constructed such that a club card, for example a grocery shopper's card, or a credit card, can be received within cavity 50 and carried inside article 10 while article 10 is affixed to key ring 8. In the embodiment illustrated in FIG. 4, cavity 50 is oriented along a vertical axis of article 10 such that a card is received at a cavity opening proximal to handle 3 of article 10.

### FIG. 5

FIG. 5 illustrates a tactile reminder device according to an embodiment of the invention providing an alternative configuration for cavity 80. In this embodiment, cavity 80 is oriented along a horizontal axis of article 10 such that a card is received at a cavity opening proximal to a side edge of article 10. As will be apparent from the drawing figures and description provided herein, any orientation of cavity 50 with respect to article 10 is suitable for use in various embodiments of the invention.

### FIG. 6

FIG. 6 illustrates a tactile indicating article 10 having a card disposed within a cavity 50 according to an embodiment of the invention. In the embodiment illustrated in FIG. 6, two handles 3 are affixed to article 10. A first handle is affixed to a front body portion 5, and a second handle is affixed to a rear body portion 1. In this embodiment, article 10 more realistically resembles an actual full scale shopping bag.

### FIG. 7

FIG. 7 illustrates an alternative embodiment of tactile indicating article 10 according to an embodiment of the invention. In the embodiment illustrated in FIG. 7 front and rear body portions 5 and 1 define a cavity 18 suitable for receiving a card (example card illustrated in FIGS. 4-6). In that manner, a card may be held securely inside cavity 18 of article 10 while article 10 is carried on a key retaining device.

In some embodiments of the invention, means for securing top portions of body portions 5 and 1 to each other are provided. For example, snaps, Velcro™ or other fastening means are provided such that cavity 8 can be substantially enclosed while article 10 is attached to a key retaining device, thereby preventing card 50 from escaping from the cavity 18 during use.

### FIG. 8

FIG. 8 illustrates a representative example of a conventional full scale shopping bag 800. A typical conventional re-usable shopping bag generally comprises a top defining a bag opening, a closed bottom, and a central body portion extending between the top and bottom. In particular, bag 800 has a front surface 850 defined by front side edges 819 and 820. Bag 800 has a back surface 851 defined by back side edges 854, 853 (853 not visible). Bag 800 includes a right side surface 855, and left side surface 856, and a bottom surface 831 (not visible). An opening 841 provides access to interior surfaces defining a chamber for receiving and stowing items to be carried in bag 800.

In the embodiment of FIG. 8 the shopping bag 800 includes gripping means. The gripping means typically comprise handles 828, 829 which are typically formed by lengths of flexible and strong strap material. The handles 828, 829 have end parts fixed respectively to the upper edges of the two opposite sides 850 and 851 of the bag 800. Therefore, the user is provided with two handles 828, 829, opposite to one another and which the user can grip so as to carry the bag. The size of the strap forming the handles is typically sufficient to be loosely wrapped around the palm of the hand.

Re-usable bags 800 are typically approximately the same size as paper shopping bags used today in many grocery stores in the United States. A typical re-usable shopping bag 80 is made of a durable material, for example a canvas material, a nylon material, a denim material, or the like. Other re-usable bags could be made of other fabric or paper material.

### FIG. 9

Currently environmentally conscious organizations and other groups have become interested in providing citizens with re-usable shopping bags designed for carrying purchased items. Such groups have an interest in branding that reflects the group's environmentally conscious approach. Therefore, in some circumstances it would be desirable to provide indicating articles of the invention as promotional items.

FIG. 9 illustrates an indicating article 900 comprising an indicating device 999 according to an embodiment of the invention. In the embodiment illustrated in FIG. 9, indicating article 900 includes a logo receiving portion 980. Logo receiving portion 980 provides a convenient mechanism for affixing, or inserting a tag, label, or other indicator to indicating article 900. Thus, for example, a corporate sponsor may have their logo printed on the logo receiving portion 980. For example, an indicating article corresponding to a particular store's grocery bag includes the name of a sponsor, such as a grocery chain, that provides the indicating article. In other examples, an indicating article corresponding to a particular store's grocery bag includes the name of the store that provides the full scale grocery bag printed on the indicating article.

It will be readily appreciated that the placement of logo receiving portion 980 on the front portion 950 of article 900 can vary from the position indicated in FIG. 9. However, logo receiving portion 980 is preferably placed in a region of bag 900 which corresponds to a surface of bag 980 which is significantly visible to a shopper or other human observer when the article is carried on key retaining receptacle 908.

### FIG. 10

FIG. 10 illustrates an indicating article 1000 comprising an indicating device 1099 according to an embodiment of the invention. Indicating article 1000 comprises an example response article corresponding to bag 800 illustrated in FIG. 8. As a response article, the article 1000 illustrated in FIG. 10 is a miniature replica of bag 800. However, an indicating article for response article 800 need not be an identical replica to bag 800 in any particular respect. As long as at least one tactile feature of indicating article 1000 provides a tactile stimulus related to a feature of response article 800, the indicating article is suitable for use in the context of the present invention.

### FIG. 11

FIG. 11 illustrates an indicating article 1100 comprising an indicating device 1199 according to an embodiment of the invention. In the embodiment illustrated in FIG. 11, indicating device 1100 comprises a substantially rectangular swatch of fabric defined by side edges 1120 and 1119, a top edge 1172 and a bottom edge 1131. Indicating article 1100 includes at least one handle portion 1129 including an opening for passing through a key retaining device 1108. In one embodiment of the invention indicating device 1100 is further defined by having a generally soft and pliable shape.

According to this embodiment indicating article 1100 is substantially flat. In that sense article 1100 represents a response article such as bag 800 in that article 1100 has a generally similar shape and a generally comparable texture. In one embodiment of the invention, article 1100 is fabricated of a readily pliable material such as canvas or other cloth material. In one embodiment of the invention, article 1100 is characterized by a relatively coarse texture when compared to a smoother texture of a metal surface such as key 1013, key retaining device 1108 and conventional metallic and plastic key fobs which may also be affixed to key retaining device 1108.

When article 1100 contacts the hand of a shopper the difference in texture associated with article 1100 is perceptible to the shopper. That is, article 1100 provides a tactile sensation which is different than the sensation imparted by a key or other conventional article attached to key retaining device 1108. The sensation associated with contact of article 1100 with a shopper's hand serves as a reminder to the shopper to retrieve the associated response article, e.g., bag 800 from its stowed location.

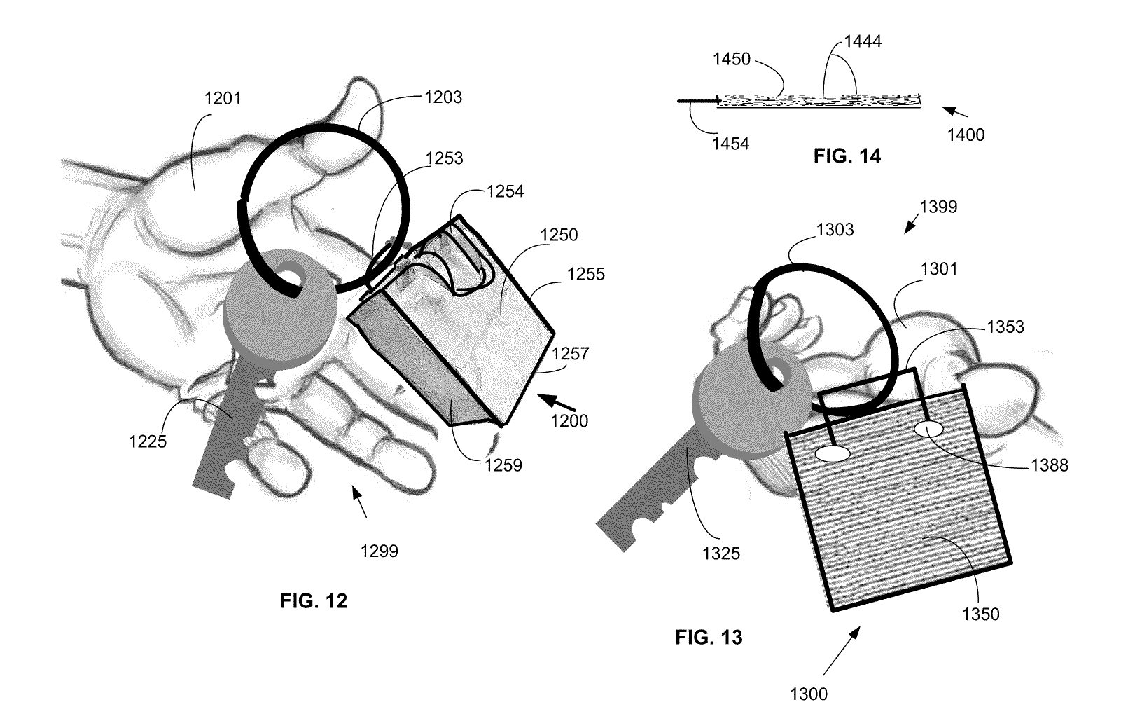

### FIG. 12

FIG. 12 illustrates an indicating article 1200 comprising an indicating device 1299. A key 1225 of the indicating device is in the grasp of a person, for example, a shopper. As illustrated in FIG. 12, an indicating article 1200 comprises a scaled replica of an actual shopping bag (as illustrated in FIG. 8). Article 1200 is illustrated in contact with at least a portion of the shopper's hand 1201 (a portion comprising a potion of the fingers in the illustration) as the shopper grasps key 1225. When in contact with a potion of a shopper's hand, attributes of indicating article 1200 are perceptible to the shopper through the sensation of touch. Indicating device 1255 positions indicating article 1200 with respect to key 1225 such that indicating article 1200 is in likely to contact at least a portion of the shopper's hand as the shopper grasps key 1225. In other words, indicating device 1255 ensures positioning of indicating article 1200 with respect to key 1225 such that indicating article 1200 delivers a tactile indicator to the shopper when the shopper grasps key 1225.

### FIG. 13

FIG. 13 illustrates an indicating article 1300 comprising an indicating device 1399 according to an embodiment of the invention. FIG. 13 illustrates a hand 1301 of a shopper as the shopper reaches for a key 1325 to which an indicating article 1300 is coupled. In this embodiment an indicating article 1300 comprises a generally rectangular flap 1350. In one embodiment of the invention, flap 1350 comprises a swatch of soft, flexible material. In one embodiment of the invention, the material is cloth. A wide range of cloth fabrics are suitable for various embodiments of the invention. Examples of suitable materials include canvas, denim, cotton, silk, wool and the like. In addition, other materials such as nylon, rubber, pliable plastic and various other materials may be suitable for use in alternative various embodiments of the invention as long as such materials are characterized by a soft and flexible flap so as to evoke a feel associated with a response article such as a re-usable shopping bag.

Indicating article 1300 includes a coupling portion 1353. In the embodiment illustrated in FIG. 13, coupling portion 1353 comprises at least one strap. In the embodiment illustrated in FIG. 3, strap 1353 is generally rectangular in shape. However, the invention is not limited with respect to any particular shape of strap 1353. Strap 1353 includes end portions affixed to an end portion of flap 1350. Strap 1353 defines an opening 1354 for passing at least a portion of a key retaining ring 1303 there through. Strap 1350 engages key retaining ring 1303 to retain flap 1350 in proximity to key 1325. At the same time, strap 1350 permits movement of flap 1350 about retaining ring 1303 such that flap 1350 is free to move into contact with a shopper's hand under the force of gravity, when key 1325 is grasped by a shopper. In one embodiment of the invention, strap 1353 is affixed to flap 1350 by glue, sewing, tacking or otherwise securely affixing strap ends to flap 1350.

### FIG. 14

FIG. 14 illustrates a side elevation view of an indicating article 1400 according to an embodiment of the invention. Article 1400 comprises an example material characterized by a texture suitable for providing a tactile stimulus corresponding to a texture of a response article such as reusable shopping bag 800, illustrated in FIG. 8. According to this example embodiment, shopping bag 800 comprises a coarse texture such as canvas, denim or burlap.

Likewise, as seen from the illustration in FIG. 14, at least a front surface 1450 of article 1400 is defined by surface variations 1444 similar in nature to canvas, denim, or burlap. In other embodiments of the invention front surface 1450 of article 1400 is substantially the same material as a corresponding response article 800.

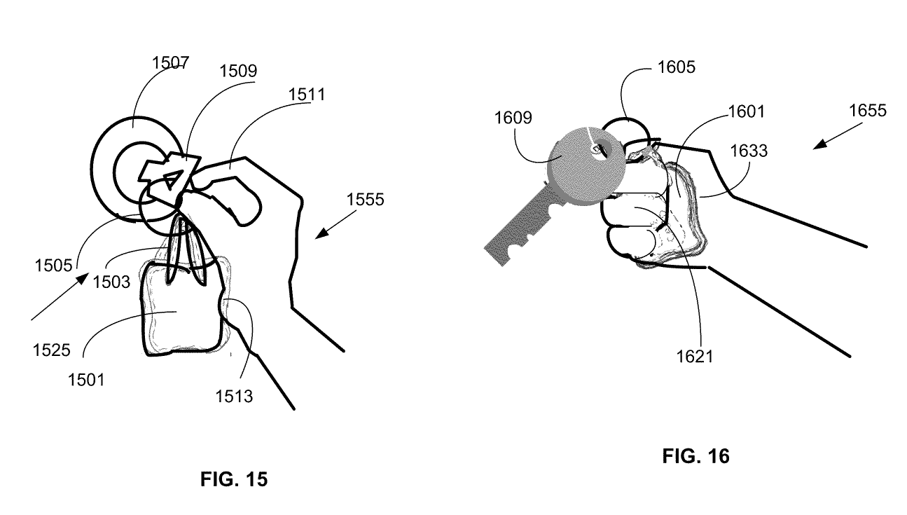

### FIG. 15

FIG. 15 illustrates an indicating article 1501 coupled to a key retaining device, e.g., key ring 1505 including an ignition key 1509 inserted into an ignition lock 1507 of a vehicle such as an automobile. In an example deployment of indicating article 1501, an automobile driver grasps key 1509 using fingers 1511 of the driver's hand 1555. For example, a driver stops his or her vehicle at a grocery store to shop for groceries. Upon stopping the vehicle and before exiting the vehicle, the driver 1550 extends the driver's hand 1511 to remove key 1509 from ignition 1507. In the process of removing key 1509, article 1501 contacts a portion 1513 of the driver's hand 1555. In one embodiment of the invention, article 1501 has a generally rectangular shape. In one embodiment of the invention, a surface area of article 1501 corresponds generally to a surface area of a palm of a human hand.

In one embodiment, article 1501 is formed of a pliable material such that substantially the whole surface area of article 1501 is readily deformable and compressible by the person grasping the article. In that case, contact between substantially the entire article surface area and the palm of the person's hand may be effected by closing the hand.

### FIG. 16

FIG. 16 illustrates an indicating article 1501 contacting a person's hand according to an embodiment of the invention. In this embodiment, substantially the entire article 1601 is in contact with a palm area 1633 of a person's hand 1655. According to other embodiments of the invention, article 1601 may be smaller or larger than illustrated in FIG. 16, when compared to a palm of a person's hand.

Articles according to preferred embodiments of the invention are sufficiently small that at least 50% of the article surface may be brought into contact with a person's hand, by the person grasping the article, or by the person grasping a key to which the article is coupled by a key retaining device such that the article is simultaneously within grasp of the person. At the same time, an article is large enough to provide a sensation perceivable by touch to an average person when the article comes into contact with the person's hand.

### FIG. 18

FIG. 18 illustrates a person, for example a shopper 1800 extending the shopper's hand 1855 into a pocket 1880 of the shopper's clothing. Disposed within pocket 1880 is an indicating article 1801 according to an embodiment of the invention. Indicating article 1801 comprises a substantially rectangular body potion and includes at least one handle portion 1802 attached proximate to an end of the substantially rectangular body portion 1802. Handle portion 1802 engages a portion of a key retaining device 1805. Key retaining device 1805 comprises a key ring in one embodiment of the invention. According to variations of the invention, key retaining device is a carabiner, a key fob, or other key retaining mechanism. At least one key 1809 is coupled to key retaining device 1805.

When hand 1855 is inserted into pocket 1880, as when withdrawing a key 1809, shopper 1555 perceives indicating article 1801 through the sense of touch due to at least a portion of indicating article 1801 contacting at least a portion of the shopper's hand 1855, for example a portion of fingers 1821.

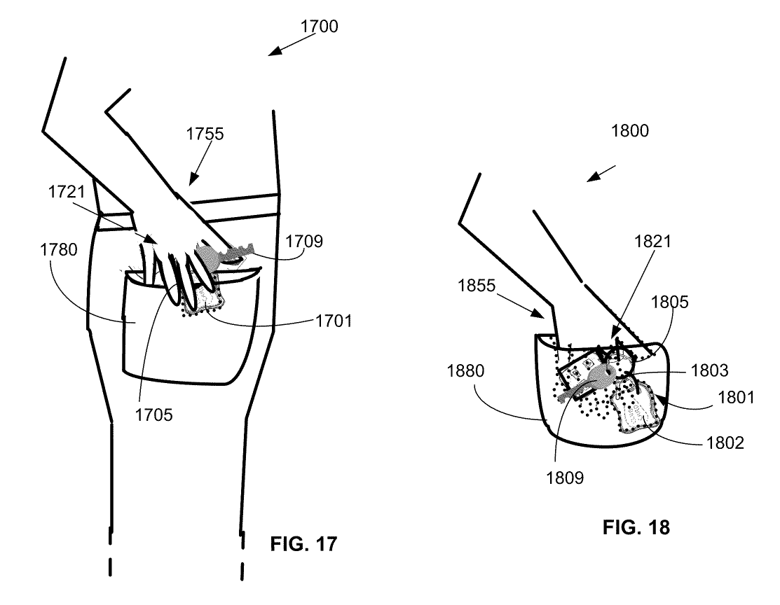

### FIG. 17

FIG. 17 illustrates a person 1700 grasping a key 1709 to which an indicating article 1701 is coupled via a key retaining device 1705, as when the person more completely withdraws key 1709 from pocket 1780 with reference to FIG. 18. As illustrated, a substantial portion of indicating article 1701 is brought into contact with at least a portion of hand 1755 simultaneously with the contact of key 1709 with hand 1755 as key 1709 is withdrawn.

As illustrated in FIGS. 17 and 18, when a person withdraws key 1709/1809 from pocket 1780/1880, for example, to open a car door when embarking on a shopping trip, the person is alerted via the sense of touch imparted by contact of article 1701/1801 with the person's hand, to the advisability of retrieving a re-usable shopping bag. According to one embodiment of the invention, article 1701/1801 has a shape substantially similar to a full scale shopping bag. Therefore, a shopper is further alerted via the sense of vision, when viewing the article 1701/1801, to retrieve a full scale shopping bag.

While the invention has been shown and described with respect to particular embodiments, it is not thus limited. Numerous modifications, changes and enhancements will now be apparent to the reader. All of these are intended to remain within the scope of the invention described herein.

I claim:

1. An indicating article comprising:
a body portion comprising a down-scaled representation of a re-usable shopping container;
a coupling portion affixed to the body portion and including an opening adapted to slidably couple the body portion to a key retaining device so as to enable the body portion to contact a person's hand when the person grasps a key of the key retaining device;
the body portion defining a characteristic feature of the re-usable shopping container, the characteristic feature perceptible to the touch of the person grasping the key;
the indicating article thereby delivering a tactile indicator of the re-usable shopping bag when the person grasps the key.

2. The indicating article of claim 1 wherein the characteristic feature comprises texture.

3. The indicating article of claim 1 wherein the characteristic feature comprises shape discernable by touching the article.

4. The indicating article of claim 1 wherein the characteristic feature comprises a shape resembling a shopping bag, the shape perceivable by vision.

5. The indicating article of claim 1 wherein the body portion comprises a swatch of fabric having a tactile texture corresponding to the tactile texture of the re-usable shopping container.

6. The indicating article of claim 1 wherein the body portion comprises a swatch of fabric corresponding in texture and shape to the re-usable shopping container.

7. The indicating article of claim 1 wherein the body portion comprises a down-scaled substantially identical replica of a re-usable shopping container.

8. The indicating article of claim 1 wherein the coupling portion comprises a downscaled replica of at least one handle portion of the re-usable shopping bag.

9. The indicating article of claim 1 wherein the characteristic feature comprises shape and texture.

10. A method for reminding a shopper to retrieve a stowed re-usable shopping bag comprising:
providing a scaled model of the re-usable shopping bag, the scaled model comprising at least one characteristic of the re-usable shopping bag;
coupling the scaled model to a key retaining device such that the scaled model contacts a shoppers hand as the shopper grasps a retained key;
delivering a stimulus associated with the characteristic to the shopper's hand via the scaled model when the shopper grasps the retained key, thereby reminding the shopper to retrieve the stowed re-usable shopping bag.

11. The method of claim 10 wherein the step of delivering the stimulus comprises delivering a tactile stimulus, wherein the tactile stimulus is associated with a tactile property of the re-usable shopping bag.

12. The method of claim 10 wherein the tactile stimulus comprises a texture, the texture associated with a texture of the re-usable shopping bag.

13. The method of claim 11 wherein the scaled model defines a shape characteristic of the re-usable shopping bag and wherein the shape provides a visual stimulus. \

14. An indicating device comprising:
a key retaining device;
at least one key coupled to the key retaining device;
an indicating article comprising a material characterized by a texture representing a corresponding response article;
the indicating article coupled to the key retaining device such that the indicating article contacts a hand of a person when the person grasps the key, such that the texture of the indicating article is perceptible to the person via the contact,
the perception indicating the response article to the person.
